(19) United States
(12) Patent Application Publication
(10) Pub. No.: US 2021/0209636 A1
(43) Pub. Date: Jul. 8, 2021

(54) CALCULATOR TO ESTIMATE HEDGE IN INVENTORY

(71) Applicant: HULU, LLC., Santa Monica, CA (US)

(72) Inventors: Yanrong Kang, Beijing (CN); Chunyang Wei, Beijing (CN)

(21) Appl. No.: 16/692,109

(22) Filed: Jan. 2, 2020

(51) Int. Cl. G06Q 30/02; G06Q 10/06

(52) U.S. Cl. CPC G06Q 30/0244; G06Q 10/067

(57) ABSTRACT

In some embodiments, a method receives original placement opportunities for one or more campaigns and determines whether to enlarge a goal or add new campaigns for the campaigns. The method enlarges the goal for the one or more advertisements or adds more campaigns for a plurality of delivery pressure values. Delivery of advertisements is simulated for the campaigns based on the added campaigns or enlarged goal to generate a simulated delivery of advertisements for the plurality of delivery pressure values. An area of demand is generated for a portion of the plurality of delivery pressure values based on an under-delivery of advertisements compared to an advertisement inventory. The method calculates a difference between a maximum delivery of advertisements based on the simulated delivery of advertisement and the inventory of advertisements in the area of demand.

### BACKGROUND

Advertising inventory is a number of advertisements that a provider has available to sell to advertisers. For example, the provider may sell advertising inventory that may be played during advertising breaks while the provider is streaming videos to users. To accurately determine the advertising inventory that may be available, the provider may use an inventory forecasting tool to calculate the advertising inventory, which may then guide advertising sales, planning, and other advertising services. However, the forecasted advertising inventory is often larger than the actual monetizable number of advertisements that the provider could deliver. That is, the provider may not be able to deliver the full number represented by the advertising inventory due to various factors, such as wastage by an ad server configured to deliver advertisements, delivery constraint rules, or other factors. The wastage of ad server delivery may be wastage of inventory allocation, industry separation, and/or brand isolation, and delivery constraint rules may apply when there is an opportunity to place an advertisement, but the provider cannot fill the advertisement due to the advertisement's delivery constraints. One example of a delivery constraint is frequency capping requiring that the same user can only see an advertisement once in one hour. When there is a difference between the forecasted advertising inventory and the actual monetizable number of advertisements that the provider could deliver, problems may occur where advertisements that have been sold may not be delivered as guaranteed.

### BRIEF DESCRIPTION OF THE DRAWINGS

With respect to the discussion to follow and in particular to the drawings, it is stressed that the particulars shown represent examples for purposes of illustrative discussion, and are presented in the cause of providing a description of principles and conceptual aspects of the present disclosure. In this regard, no attempt is made to show implementation details beyond what is needed for a fundamental understanding of the present disclosure. The discussion to follow, in conjunction with the drawings, makes apparent to those of skill in the art how embodiments in accordance with the present disclosure may be practiced. Similar or same reference numbers may be used to identify or otherwise refer to similar or same elements in the various drawings and supporting descriptions. In the accompanying drawings:

FIG. 1 depicts an example of a system for generating a hedge calculation according to some embodiments.

FIG. 2 depicts a simplified example showing the under-delivery of advertisements according to some embodiments.

FIG. 3 depicts a simplified flowchart of a method for generating a hedge calculation according to some embodiments.

FIG. 4 depicts a more detailed example of a campaign manager according to some embodiments.

FIG. 5 depicts an example of a flowchart for increasing demand of advertisement according to some embodiments.

FIG. 6 depicts an example of an ad server simulator according to some embodiments.

FIG. 7 depicts a more detailed example of a hedge analyzer according to some embodiments.

FIG. 8A depicts a graph when the goal is enlarged according to some embodiments.

FIG. 8B depicts a graph when campaigns are added according to some embodiments.

FIG. 9 depicts a simplified flowchart of a method for generating the hedge calculation according to some embodiments.

FIG. 10 depicts a video streaming system in communication with multiple client devices via one or more communication networks according to one embodiment.

FIG. 11 depicts a diagrammatic view of an apparatus for viewing video content and advertisements.

### DETAILED DESCRIPTION

Described herein are techniques for a calculation system. In the following description, for purposes of explanation, numerous examples and specific details are set forth in order to provide a thorough understanding of some embodiments. Some embodiments as defined by the claims may include some or all of the features in these examples alone or in combination with other features described below and may further include modifications and equivalents of the features and concepts described herein.

Some embodiments generate a hedge calculation that represents the difference between the inventory of advertisements and the actual number of advertisements that could be delivered. The hedge calculation may be used to determine a number of advertisements that can be used in a video delivery service, such as a guide for ad budgeting and sales. This may help the provider when offering advertisement sales of advertising inventory and may improve the correlation between advertising sales and the actual number of advertisements that are delivered.

The generation of the hedge calculation may be difficult because it depends on the provider's video traffic (e.g., number of videos served to users), ad campaign parameters, ad server operation, and delivery constraints, all of which may vary with time and operation. In some embodiments, the hedge calculation uses the relationship between ad campaigns and delivered advertisements to generate the hedge calculation. The system may use a campaign manager to model how ad campaigns change over time such that a hedge calculation can be performed. For example, the hedge calculation should evaluate the under-delivery of advertisements for different points of delivery pressure. This is different from delivering ads. The system needs to increase or decrease delivery pressure for the delivery of advertisements. To do so, the campaign manager may receive original placement opportunities for one or more ad campaigns and determine whether to enlarge a placement goal for the one or more campaigns or add new campaigns. Enlarging a goal may increase the number of times for delivering advertisements for the ad campaign and adding new campaigns may increase the number of campaigns that are eligible to place advertisements.

To simulate the operation of delivering advertisements, the campaign manager may enlarge the goals for one or more ad campaigns and/or add more campaigns to meet delivery pressure requirements that are needed to perform the hedge calculation. Then, the system may simulate the delivered advertisements for the one or more campaigns based on the added campaigns or larger goals. For example, an ad server may simulate the delivery of advertisements based on different factors. The ad server then outputs the number of delivered advertisements.

An analyzer may calculate the difference between an advertisement inventory of advertisements and a maximum delivery of advertisements based on different delivery pressures during a period of time as a hedge calculation. The provider may then use the hedge calculation along with the advertisement inventory when performing some services. For example, the provider may not use the entire advertising inventory, but instead may use a different number based on the hedge calculation and the advertising inventory.

System Overview

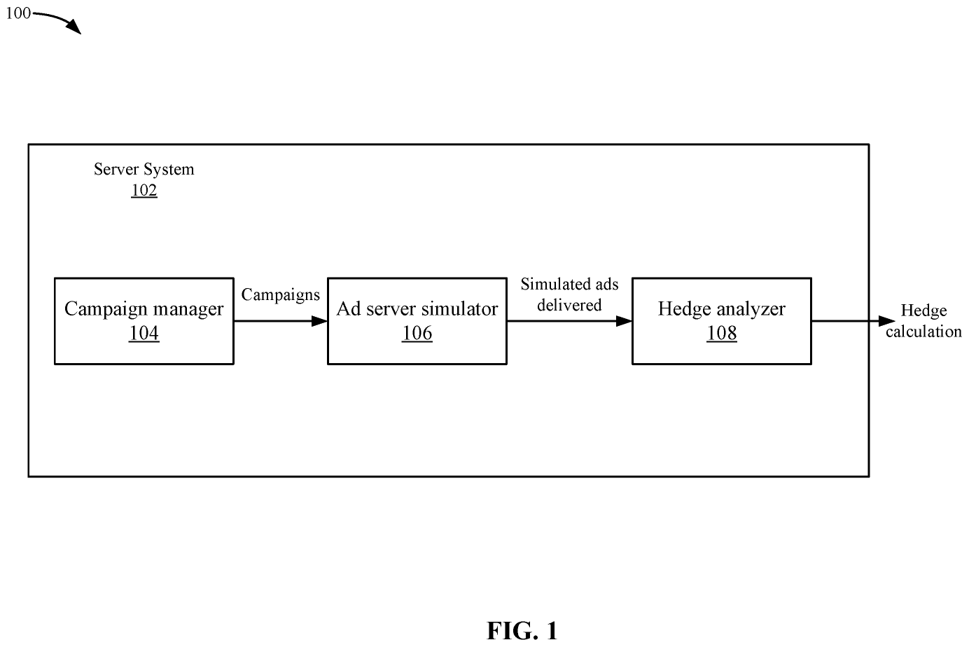

FIG. 1 depicts an example of a system 100 for generating a hedge calculation according to some embodiments. A server system 102 includes a campaign manager 104, an ad server simulator 106, and a hedge analyzer 108. The functions described may be included on a single computing device or distributed across multiple computing devices.

Campaign manager 104 may simulate the performance of ad campaigns. Many factors of ad campaigns may affect delivered advertisements, such as the goals of advertising campaigns, the variety of the advertising campaigns, the advertisement campaign targeting rules, etc. Campaign manager 104 may determine how campaigns may change within a period of time to alter delivery pressure and output the changes to the advertising campaigns to an ad server simulator 106.

Ad server simulator 106 may model the behavior of an ad server. Ad server simulator 106 may receive information needed to place advertisements, such as historical advertisement requests, ad campaigns, delivery constraints. Then, ad server simulator 106 processes the information and outputs the delivered advertisements. The historical ad requests may be requests for advertisements that may occur, such as when an advertisement break occurs while watching a video using the provider's service. Ad server simulator 106 uses the ad campaigns received from campaign manager 104 to determine the delivered advertisements based on delivery constraints. One difficult part of the ad server simulation is to align the timing of different components, which is critical to replay the ad requests according to time. Ad server simulator 104 uses a time machine to perform the time alignment.

Hedge analyzer 108 receives the simulated delivered advertisements and can generate a hedge calculation. Hedge analyzer 108 may define a reasonable area of demand. The reasonable area can be defined, such as that an under-delivery ratio cannot be higher than 20%. From that reasonable area of demand, hedge analyzer 108 calculates the maximum advertisement delivery within that area. Hedge analyzer 108 then calculates the difference between the maximum delivery and the advertising inventory in the reasonable area as the hedge calculation.

Hedge Calculation

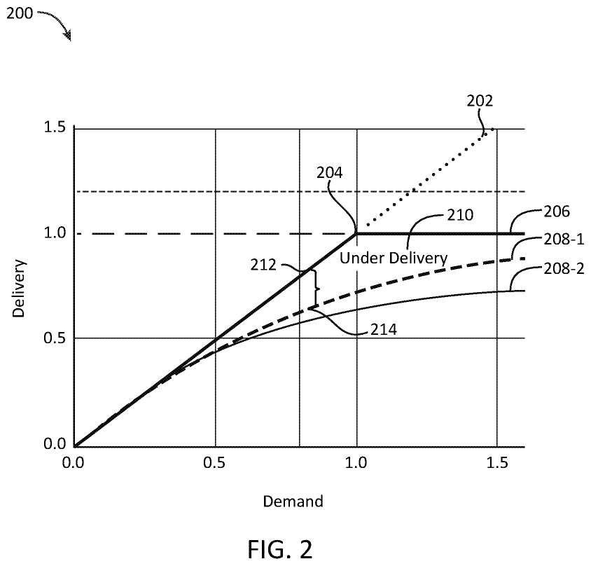

FIG. 2 depicts a simplified example 200 showing the under-delivery of advertisements according to some embodiments. The Y axis of graph 200 shows the delivery of advertisements and the X axis shows the demand for advertisements. The relationship between the delivery and the demand is plotted in graph 200.

At 202, a line represents when delivery equals demand. The demand may be the sum of the goals of the advertisement campaigns, the delivery may be the number of delivered advertisements as shown by a curve at 206. Basically, more advertisements are delivered when demand grows. An ideal curve is when delivery equals demand until it reaches the advertisement inventory at 204. After this point, there are no more advertisements to deliver and the curve at 206 does not increase any further/levels off.

In operation, delivery constraints and the imperfection of the ad server contribute to cause an actual delivery that is beneath the ideal curve at 206. A first curve 208-1 and a second curve 208-2 illustrate two different delivery possibilities. As shown, the number of advertisements that are delivered is under the ideal curve at 206. For example, the under-delivery between demand curve 208-1 and the ideal curve at 206 is shown at 210. This may be considered the hedge calculation at different points in time. Accordingly, if the provider attempted to sell a number of advertisements as shown on the ideal curve at 212, the provider might sell more advertisements than can be realistically delivered. However, using the hedge calculation, the provider may take into account the hedge and sell advertisements that may be based on a point at 214 on demand curve 208-1. Selling advertisements at a more accurate number of advertisements that might be delivered will help the provider more accurately estimate sales. However, many factors may make calculating the hedge calculation difficult as different demand (e.g., delivery pressure) needs to be generated at each time granularity over a time period.

Hedge Calculation

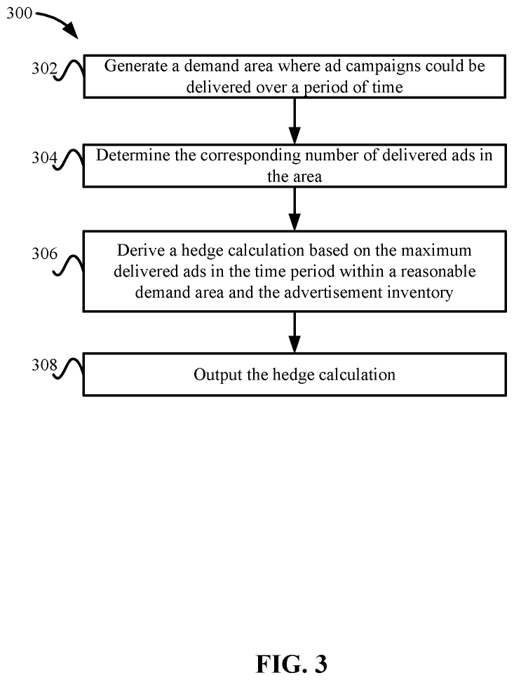

The following is a general description of the hedge calculation according to some embodiments. FIG. 3 depicts a simplified flowchart 300 of a method for generating a hedge calculation according to some embodiments. At 302 hedge analyzer 108 generates a demand area where ad campaigns could be delivered over a period of time. At 304, hedge analyzer 108 determines a corresponding number of delivered advertisements in the area. Then, at 306, hedge analyzer 108 derives a hedge calculation based on the maximum delivered advertisements in the time period within the reasonable demand area and the advertisement inventory. The hedge calculation may be the difference between the advertisement inventory and the maximum delivered advertisements within the demand area. At 308, hedge analyzer 108 outputs the hedge calculation.

To describe how to generate the above hedge calculation, the following will now describe the components of system 100 in more detail.

Campaign Manager

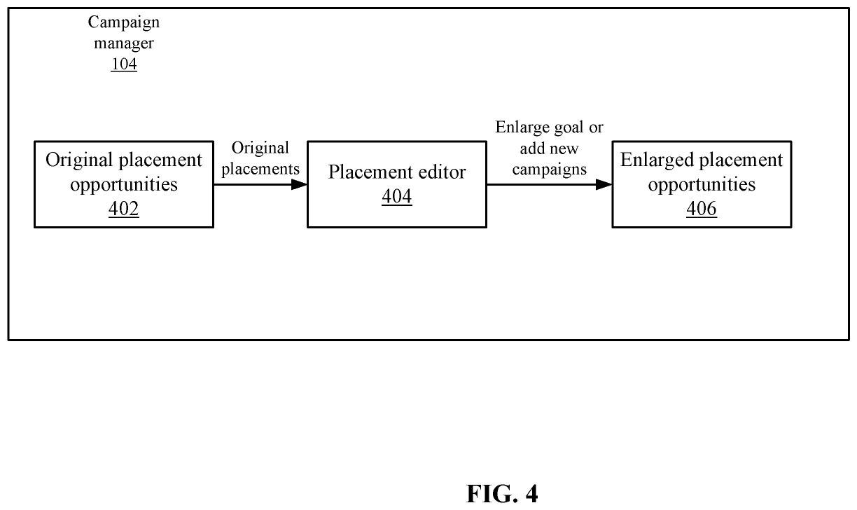

FIG. 4 depicts a more detailed example of campaign manager 104 according to some embodiments. Campaign manager 104 includes a placement editor 404 that receives original placements from original placement opportunities 402. Original placement opportunities 402 may be based on advertisement campaigns that are being used to simulate the actual delivery of advertisements. Each advertisement campaign may specify a number of placements that are desired for the ad campaign. A placement may be an impression or a delivered advertisement during an advertisement break.

Referring the FIG. 2, placement editor 404 may increase the demand as shown in FIG. 2 along curve 202. To increase the demand, placement editor 404 may use a combination of enlarging goals and adding campaigns. In some embodiments, placement editor 404 may adjust the original placement opportunities to increase demand by enlarging the goals of existing campaigns for advertisement campaigns, adding new campaigns for the advertisement campaigns, or combining both the enlarging of goals and the adding of new campaigns. One purpose of enlarging the goals or adding campaigns is to increase the delivery pressure, which allows different points on the delivery/demand curve to be drawn. In some embodiments, the hedge calculation may be derived using these two methods of increasing demand. The result of enlarging the goals or adding new campaigns may be enlarged placement opportunities 406.

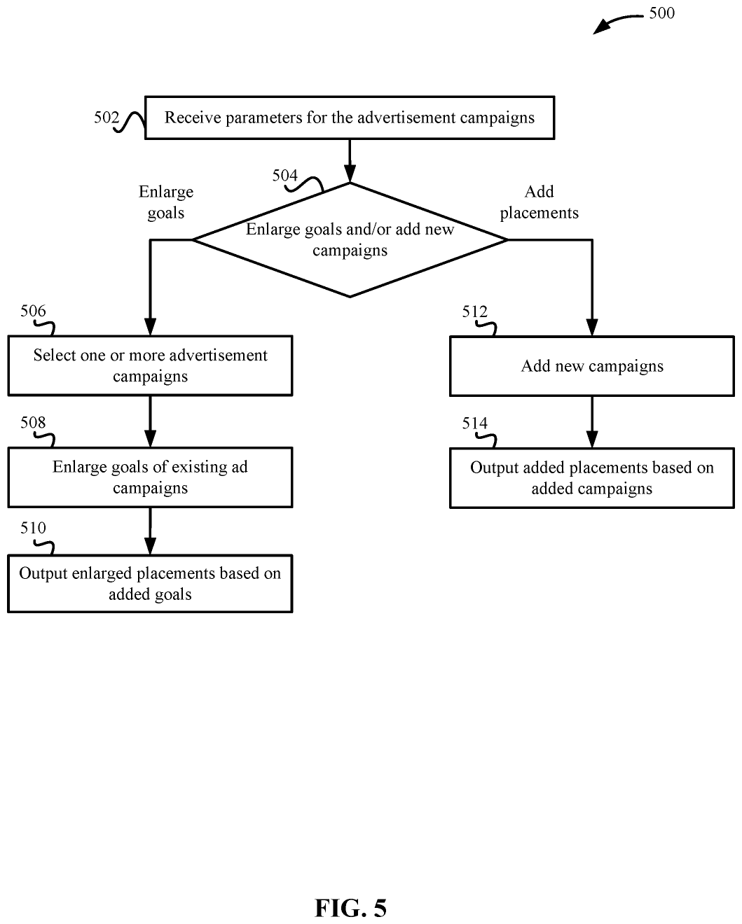

FIG. 5 depicts an example of a flowchart for increasing demand of advertisement according to some embodiments. At 502, placement editor 404 receives the parameters for advertisement campaigns. The parameters describe the requirements for advertisement campaigns, such as the goals of the ad campaign. At 504, placement editor 404 enlarges goals and/or adds new campaigns. Placement editor 404 determines how much to enlarge the goals or add campaigns based on the desired delivery pressure. For example, if placement editor 404 wants to generate double the delivery pressure (e.g., a delivery pressure of 2.0 compared to 1.0), then placement editor 404 can increase the goals by two times or add new campaigns to make the goals double (e.g., double the number of the original campaigns).

If placement editor 404 determines that goals should be enlarged, at 506, placement editor 404 selects one or more advertisement campaigns that are found within the received advertisement campaigns. In some embodiments, all of the goals of the campaigns will enlarge at the same scale. Then, at 508, placement editor 404 enlarges the goals of the existing advertisement campaigns. For example, if a goal for a placement is 10,000 for an advertising campaign, then placement editor 404 may increase the goal of the placement to 150,000. At 510, placement editor 404 outputs the enlarged goals, which increases the deliver demand of the placement.

If placement editor 404 determines that new campaigns should be added, at 512, placement editor 404 adds new campaigns for ad campaigns. The new campaigns may be based on the original campaigns or be newly added. For example, if there are 5,000 campaigns during a time period, placement editor 404 may add 5,000 new campaigns to double the number of placements from the doubled campaigns during the time period. The 5,000 campaigns are added to the already existing 5,000 campaigns, which enlarges the number of campaigns that are available. Then, at 514, placement editor 404 outputs the added campaigns.

Ad Server Simulator

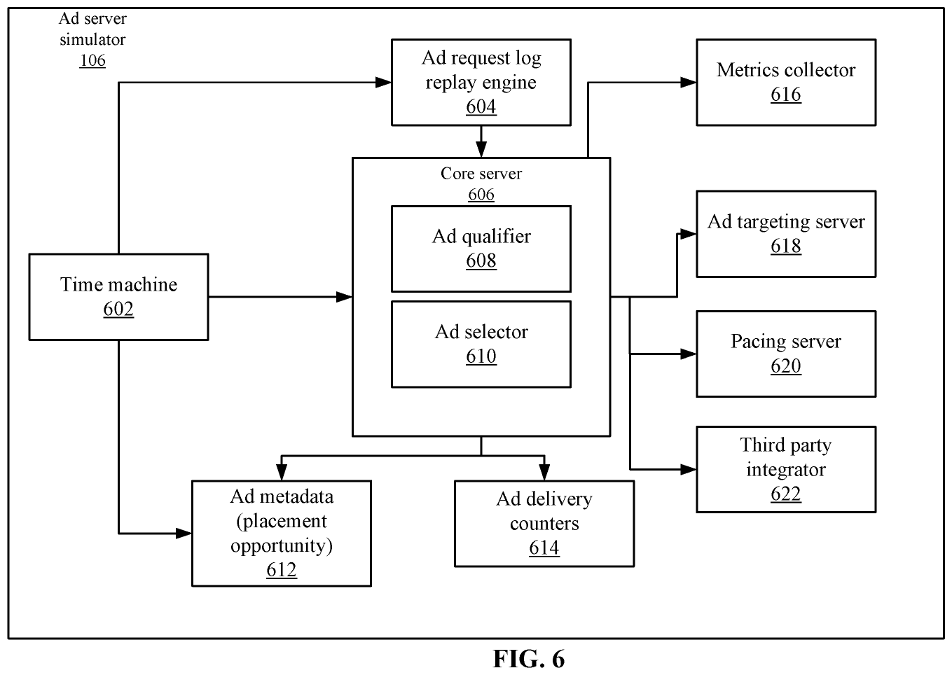

An ad server simulator 106 receives the outputted placements from campaign manager 104. FIG. 6 depicts an example of ad server simulator 106 according to some embodiments. Ad server simulator 106 includes a time machine 602 that controls the speed of ad requests in ad request log replay engine 604 and also other time-related components for an ad server, such as the date status for ad metadata. The time machine keeps a centralized time, and can control the time to go faster, such as 10 times or 20 times faster. And it will be connected to each component to inject the centralized time to different components to control delivery pressure. Accordingly, ad request log replay engine 604 may replay the historical ad requests. That is, the number of ad requests that may be experienced while streaming video to users may be replayed.

A core server 606 may include an ad qualifier 608 and an ad selector 610. Ad qualifier 608 may qualify an advertisement for a placement opportunity. That is, when an ad request is received, ad qualifier 608 may qualify which advertisements are eligible for the ad request. Ad selector 610 may then select one of those advertisements for placement in the ad request.

Ad metadata (placement opportunity) 612 is metadata about the placement opportunities. Ad delivery counter 614 counts how many times advertisements are delivered. Ad selector 610 may use the ad metadata and ad delivery counters when selecting the advertisements. For example, some advertisements may not be qualified for an ad request when they have met ad delivery requirements. Ad qualifier 608 may use ad metadata to determine which advertisements qualify for an ad request. Ad metadata contains the information of the campaigns, for example the targeting rules of the campaigns, the goals of the campaigns, the running period of the campaigns, etc.

Ad targeting server 618 may be used by ad qualifier 608, which is before ad selector 610 selects ads. The ad server will firstly determine which ad campaigns are qualified according to targeting of certain audience characteristics by ad targeting server 618. Pacing server 620 may determine whether the pace of advertisements in an ad campaign is meeting the pacing requirements of the ad campaign. Pacing server 620 tracks the pacing status of each ad campaign, then ad selector 610 can select the ad according to the pacing status. Third party integrator 622 integrates advertisements from external resources.

Metrics collector 616 may collect metrics for the advertisement delivery for ad server simulator 106. These metrics may define the advertisements that are delivered during advertisement breaks and can be input into hedge analyzer 108.

Ad server simulator 106 may determine different numbers of advertisements that are delivered based on the placements in campaigns provided by campaign manager 104. For example, when the number of placements goes up, ad server simulator 106 may also deliver more advertisements. For example, up to a point, ad server simulator 106 may deliver more advertisements for advertisement requests when placements increase as shown in FIG. 2.

Hedge Analyzer

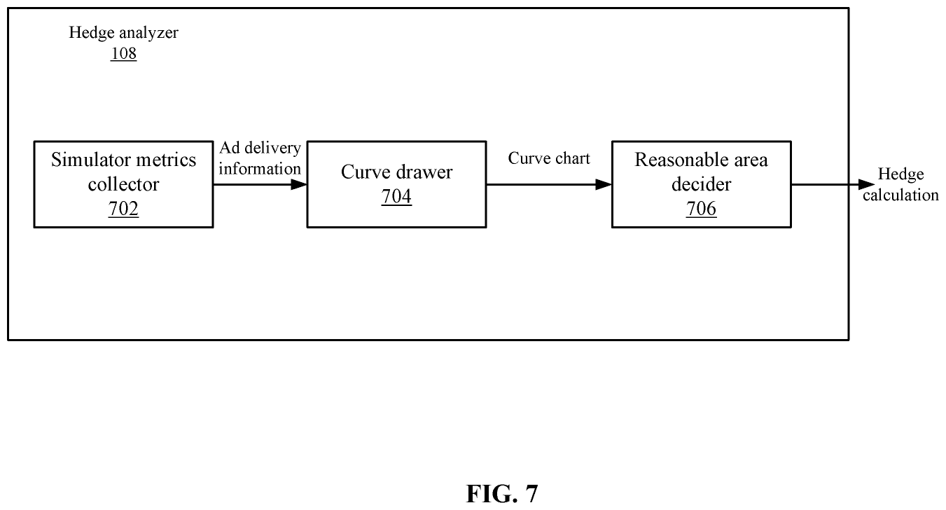

Hedge analyzer 108 uses the metrics from ad server simulator 106 to generate a hedge calculation. FIG. 7 depicts a more detailed example of hedge analyzer 108 according to some embodiments. A simulator metrics collector 702 receives the metrics from ad server simulator 106. Simulator metrics collector 702 may generate ad delivery information for a curve drawer 704. The ad delivery information may be based on the enlargement of goals or adding of new campaigns, and include the number of advertisements that are delivered as calculated based on enlargement of goals and/or the adding of new campaigns.

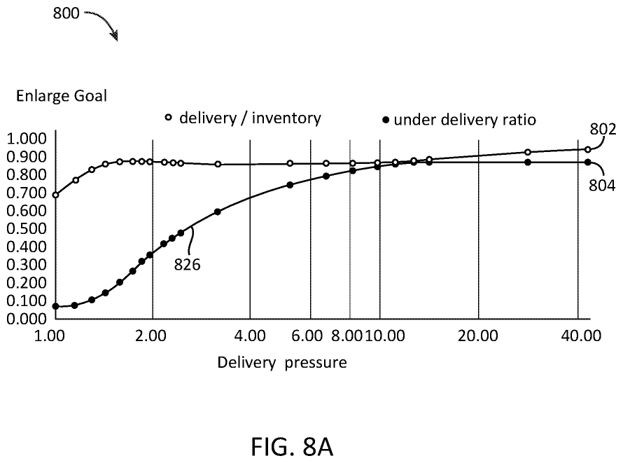

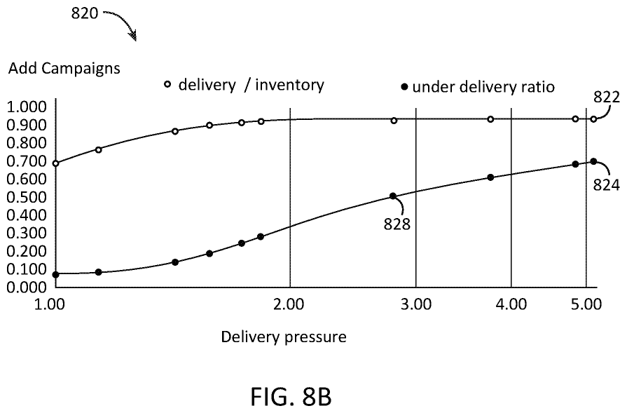

Curve drawer 704 may draw curves based on the ad delivery information. FIGS. 8A and 8B depict different curves that are drawn for enlarging goals and adding new campaigns according to some embodiments. For example, FIG. 8A depicts a graph 800 when the goal is enlarged and FIG. 8B depicts a graph 820 when campaigns are added according to some embodiments. A single point on the curve is for a different delivery pressure, and the curve is generated multiple times with different delivery pressure. In FIG. 8A, the X axis is the delivery pressure, which is demand divided by the supply. As the goals are enlarged, which means the demand goes up and leads to the delivery pressure going up. The Y axis are values from 0.0 to 1.000 representing the value of the ratios of delivery/inventory and the under delivery ratio.

A first curve 802 depicts the delivery divided by the inventory. A second curve 804 depicts information for the under-delivery of advertisements as the goals are enlarged to increase the delivery pressure or demand. In some embodiments, an under-delivery ratio is used, which is the discrepancy of delivered and the goal divided by the goal total (e.g., (goal−delivered)/goal total). As can be seen, the under-delivery ratio increases when delivery pressure increases. That is, the number of delivered advertisements compared to the total goals of advertisements that could be delivered decreases as delivery pressure increases. Also, as delivery pressure increases, curve 804 increases as deliveries of advertisements increases with increased delivery pressure.

In FIG. 8B, as campaigns are added, the delivery pressure goes up. A first curve 822 depicts the delivery of advertisements divided by the advertisement inventory for the number of advertisements that are available. A second curve 824 depicts the under-delivery ratio as campaigns are added. As can be seen, the under-delivery ratio is small when delivery pressure is low. However, as delivery pressure increases, the under-delivery ratio increases as shown by curve 824. Further, curve 822 increases as deliveries of advertisements increases with increased delivery pressure.

Curve 824 for the under-delivery ratio for adding new campaigns has different characteristics from curve 804 that results from the enlarging of goals. For example, the values of the under-delivery ratio are different based on different delivery pressures. As discussed above, campaign manager 104 adjusts the new campaigns to increase the delivery pressure so curve 804 can be drawn. Also, the speed of the increase of under-delivery ratio based on delivery pressure is different when adding campaigns and enlarging goals.

Hedge analyzer 108 may use a reasonable area of demand to calculate the hedge. For example, a reasonable area decider 706 may determine a reasonable area of demand. The reasonable area may be defined by business requirements, for example, the under-delivery ratio cannot be higher than 0.50. The smaller the under-delivery ratio means that there is less under-delivery of advertisements compared to the advertisement goal. Within this reasonable area of demand, hedge analyzer 108 determines the maximum delivery of advertisements within the area. The gap between the maximum delivery and the ad inventory is used to determine the hedge calculation.

In some examples, the reasonable area is where the under-delivery ratio is below a threshold. The under-delivery ratio is X %, which means there are X % of the placement goals that fail to deliver. The smaller percentage means that less placement goals fail to deliver. For example, the under-delivery ratio in FIG. 8A or 8B may be below 0.5. Also, the reasonable area in this case may be the area before the under-delivery ratio reaches 0.5. In FIG. 8A, curve 804 reached 0.5 for the under-delivery ratio at 826. In FIG. 8B, curve 824 reached 0.5 for the under-delivery ratio at 828. The reasonable area may be larger in FIG. 8 as curve 824 reaches 0.5 for the under-delivery ratio at 828 later than curve 804 at 826. This is because the speed of increase in the under-delivery ratio is slower when adding campaigns.

Also, the reasonable area is where the delivery still increases with demand and the speed of increase is above a threshold. In this case, when the speed of the increase is above the threshold, then the reasonable area is determined. For example, in FIG. 8A, the speed of the increase may go above a threshold faster than in FIG. 8B because the speed of the increase of demand for adding campaigns in FIG. 8B is slower. In this case, in FIG. 8B, the speed of the increase may be reached at a much later point where the delivery pressure is higher compared to in FIG. 8A.

Once the reasonable area is determined, hedge analyzer 108 may determine a total for the maximum delivery of advertisements in the reasonable area. Then, hedge analyzer 108 may determine the difference between the total of the ad inventory and the maximum delivery of advertisements. If the maximum delivery is 88% when enlarging goals and the maximum delivery is 93% when adding campaigns, then hedge analyzer 108 determines hedge calculation will be between 7% and 12% of the advertisement inventory. That is, the hedge may be 7% when adding campaigns and 12% when enlarging goals, which forms the minimum hedge and the maximum hedge possibilities.

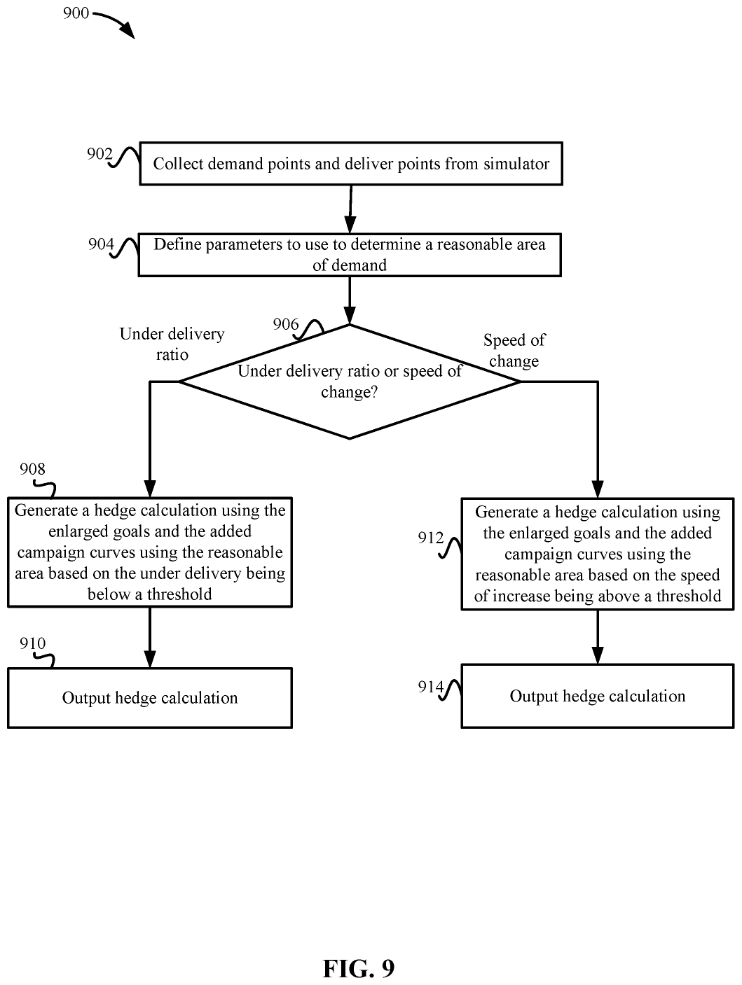

FIG. 9 depicts a simplified flowchart 900 of a method for generating the hedge calculation according to some embodiments. At 902, hedge analyzer 108 collects demand points and delivery points from ad server simulator 106. The demand points represent demand and the delivery points represent ad deliveries at those points. At 904, hedge analyzer 108 defines parameters to use to determine a reasonable area of demand. The reasonable area of demand may be selected as described above. Then, at 906, hedge analyzer 108 determines if the under-delivery ratio value or speed of change of the under-delivery ratio is to be used to determine the reasonable area of demand. If the under-delivery ratio is to be used, at 908, hedge analyzer 108 generates the hedge calculation using the enlarged goals and the added campaign curves using the reasonable area based on the under-delivery ratio being below a threshold. Then, at 910, hedge analyzer 108 outputs the hedge calculation. If speed of the change of the under-delivery ratio is to be used, at 912, hedge analyzer 108 generates a hedge calculation using the enlarged goals and the added campaign curves using the reasonable area based on delivery increasing with demand and the speed of increase being above a threshold. At 914, hedge analyzer 108 outputs the hedge calculation.

### CONCLUSION

Accordingly, some embodiments generate a hedge calculation that can be used to more accurately determine the number of advertisements that may be delivered within a time period based on the advertising inventory. This may allow a provider to more accurately perform some tasks such as determining the advertisements to sell.

### Example Embodiments

In some embodiments, a method comprising: receiving, by a computing device, original placement opportunities for one or more campaigns; determining, by the computing device, whether to enlarge a goal for the one or more campaigns or add new campaigns; enlarging, by the computing device, the goal for the one or more advertisements or adding one or more campaigns for a plurality of delivery pressure values; simulating, by the computing device, delivery of advertisements for the one or more campaigns based on the added campaigns or enlarged goal to generate a simulated delivery of advertisements for the plurality of delivery pressure values; generating, by the computing device, an area of demand for a portion of the plurality of delivery pressure values based on an under-delivery of advertisements compared to an advertisement inventory; and calculating, by the computing device, a difference between a maximum delivery of advertisements based on the simulated delivery of advertisement and the inventory of advertisements in the area of demand.

In some embodiments, determining whether to enlarge the goal or add the new campaigns comprises selecting a combination of enlarging the goal and adding the new campaigns.

In some embodiments, enlarging the goal comprises adding goals for placing advertisements for the one or more campaigns.

In some embodiments, adding the one or more campaigns comprise adding additional campaigns to place advertisements.

In some embodiments, simulating the delivery of advertisements comprises: receiving historical advertisement requests; and placing advertisements from the one or more campaigns in the historical advertisement requests.

In some embodiments, placing advertisements from the one or more campaign comprises: using the enlarged goal to place the advertisements to increase delivery pressure to one of the plurality of delivery pressure values.

In some embodiments, placing advertisements from the one or more campaign comprises: using the added campaigns to place the advertisements to increase delivery pressure to one of the plurality of delivery pressure values.

In some embodiments, generating the reasonable area of demand comprises: comparing a ratio of the under-delivery of advertisements compared to the advertisement inventory to a threshold.

In some embodiments, the threshold is a value of the ratio of the under-delivery of advertisements compared to the advertisement inventory.

In some embodiments, the threshold is a speed of change for the ratio of the under-delivery of advertisements compared to the advertisement inventory.

In some embodiments, calculating the difference between the maximum delivery of advertisements base on the simulated delivery of advertisement and the inventory of advertisements in the reasonable area of demand comprises: calculating a difference between a total of the maximum delivery of advertisements in the area of demand and a total of the inventory of advertisements in the area of demand.

In some embodiments, enlarging the goal for the one or more advertisements or adding one or more campaigns for the one or more campaigns for a plurality of delivery pressure values comprises: enlarging the goal for the one or more advertisements for each of the plurality of delivery pressure values or adding one or more campaigns for each of the plurality of delivery pressure values.

In some embodiments, simulating the delivery of advertisements for the one or more campaigns comprises: timing the placing of advertisements in the delivery of advertisements.

In some embodiments, a non-transitory computer-readable storage medium containing instructions, that when executed, control a computer system to be operable for: receiving original placement opportunities for one or more campaigns; determining whether to enlarge a goal for the one or more campaigns or add new campaigns; enlarging the goal for the one or more advertisements or adding one or more campaigns for a plurality of delivery pressure values; simulating delivery of advertisements for the one or more campaigns based on the added campaigns or enlarged goal to generate a simulated delivery of advertisements for the plurality of delivery pressure values; generating an area of demand for a portion of the plurality of delivery pressure values based on an under-delivery of advertisements compared to an advertisement inventory; and calculating a difference between a maximum delivery of advertisements based on the simulated delivery of advertisement and the inventory of advertisements in the area of demand.

In some embodiments, determining whether to enlarge the goal or add the new campaigns comprises selecting a combination of enlarging the goal and adding the new campaigns.

In some embodiments, enlarging the goal comprises adding goals for placing advertisements for the one or more campaigns.

In some embodiments, adding the one or more campaigns comprises adding additional campaigns to place advertisements.

In some embodiments, simulating the delivery of advertisements comprises: receiving historical advertisement requests; and placing advertisements from the one or more campaigns in the historical advertisement requests.

In some embodiments, generating the reasonable area of demand comprises: comparing a ratio of the under-delivery of advertisements compared to the advertisement inventory to a threshold.

In some embodiments, an apparatus comprising: one or more computer processors; and a non-transitory computer-readable storage medium comprising instructions, that when executed, control the one or more computer processors to be operable for: receiving original placement opportunities for one or more campaigns; determining whether to enlarge a goal for the one or more campaigns or add new campaigns; enlarging the goal for the one or more advertisements or adding one or more campaigns for a plurality of delivery pressure values; simulating delivery of advertisements for the one or more campaigns based on the added campaigns or enlarged goal to generate a simulated delivery of advertisements for the plurality of delivery pressure values; generating an area of demand for a portion of the plurality of delivery pressure values based on an under-delivery of advertisements compared to an advertisement inventory; and calculating a difference between a maximum delivery of advertisements based on the simulated delivery of advertisement and the inventory of advertisements in the area of demand.

System

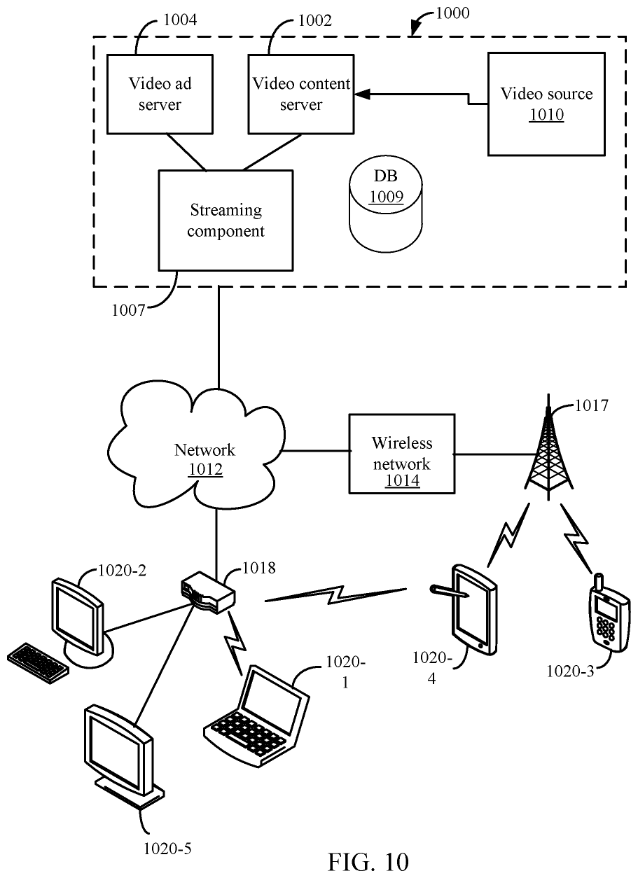

Features and aspects as disclosed herein may be implemented in conjunction with a video streaming system 1000 in communication with multiple client devices via one or more communication networks as shown in FIG. 10. Aspects of the video streaming system 1000 are described merely to provide an example of an application for enabling distribution and delivery of content prepared according to the present disclosure. It should be appreciated that the present technology is not limited to streaming video applications and may be adapted for other applications and delivery mechanisms.

In one embodiment, a media program provider may include a library of media programs. For example, the media programs may be aggregated and provided through a site (e.g., website), application, or browser. A user can access the media program provider's site or application and request media programs. The user may be limited to requesting only media programs offered by the media program provider.

In system 1000, video data may be obtained from one or more sources for example, from a video source 1010, for use as input to a video content server 1002. The input video data may comprise raw or edited frame-based video data in any suitable digital format, for example, Moving Pictures Experts Group (MPEG)-1, MPEG-2, MPEG-4, VC-1, H.264/Advanced Video Coding (AVC), High Efficiency Video Coding (HEVC), or other format. In an alternative, a video may be provided in a non-digital format and converted to digital format using a scanner and/or transcoder. The input video data may comprise video clips or programs of various types, for example, television episodes, motion pictures, and other content produced as primary content of interest to consumers. The video data may also include audio or only audio may be used.

The video streaming system 1000 may include one or more computer servers or modules 1002, 1004, and/or 1007 distributed over one or more computers. Each server 1002, 1004, 1007 may include, or may be operatively coupled to, one or more data stores 1009, for example databases, indexes, files, or other data structures. A video content server 1002 may access a data store (not shown) of various video segments. The video content server 1002 may serve the video segments as directed by a user interface controller communicating with a client device. As used herein, a video segment refers to a definite portion of frame-based video data, such as may be used in a streaming video session to view a television episode, motion picture, recorded live performance, or other video content.

In some embodiments, a video advertising server 1004 may access a data store of relatively short videos (e.g., 10 second, 30 second, or 60 second video advertisements) configured as advertising for a particular advertiser or message. The advertising may be provided for an advertiser in exchange for payment of some kind or may comprise a promotional message for the system 1000, a public service message, or some other information. The video advertising server 1004 may serve the video advertising segments as directed by a user interface controller (not shown).

The video streaming system 1000 may further include an integration and streaming component 1007 that integrates video content and video advertising into a streaming video segment. For example, streaming component 1007 may be a content server or streaming media server. A controller (not shown) may determine the selection or configuration of advertising in the streaming video based on any suitable algorithm or process. The video streaming system 1000 may include other modules or units not depicted in FIG. 10, for example, administrative servers, commerce servers, network infrastructure, advertising selection engines, and so forth.

The video streaming system 1000 may connect to a data communication network 1012. A data communication network 1012 may comprise a local area network (LAN), a wide area network (WAN), for example, the Internet, a telephone network, a wireless cellular telecommunications network (WCS) 1014, or some combination of these or similar networks.

One or more client devices 1020 may be in communication with the video streaming system 1000, via the data communication network 1012, wireless cellular telecommunications network 1014, and/or another network. Such client devices may include, for example, one or more laptop computers 1020-1, desktop computers 1020-2, “smart” mobile phones 1020-3, tablet devices 1020-4, network-enabled televisions 1020-5, or combinations thereof, via a router 1018 for a LAN, via a base station 1017 for a wireless cellular telecommunications network 1014, or via some other connection. In operation, such client devices 1020 may send and receive data or instructions to the system 1000, in response to user input received from user input devices or other input. In response, the system 1000 may serve video segments and metadata from the data store 1009 responsive to selection of media programs to the client devices 1020. Client devices 1020 may output the video content from the streaming video segment in a media player using a display screen, projector, or other video output device, and receive user input for interacting with the video content.

Distribution of audio-video data may be implemented from streaming component 1007 to remote client devices over computer networks, telecommunications networks, and combinations of such networks, using various methods, for example streaming. In streaming, a content server streams audio-video data continuously to a media player component operating at least partly on the client device, which may play the audio-video data concurrently with receiving the streaming data from the server. Although streaming is discussed, other methods of delivery may be used. The media player component may initiate play of the video data immediately after receiving an initial portion of the data from the content provider. Traditional streaming techniques use a single provider delivering a stream of data to a set of end users. High bandwidth and processing power may be required to deliver a single stream to a large audience, and the required bandwidth of the provider may increase as the number of end users increases.

Streaming media can be delivered on-demand or live. Streaming enables immediate playback at any point within the file. End-users may skip through the media file to start playback or change playback to any point in the media file. Hence, the end-user does not need to wait for the file to progressively download. Typically, streaming media is delivered from a few dedicated servers having high bandwidth capabilities via a specialized device that accepts requests for video files, and with information about the format, bandwidth and structure of those files, delivers just the amount of data necessary to play the video, at the rate needed to play it. Streaming media servers may also account for the transmission bandwidth and capabilities of the media player on the destination client. Streaming component 1007 may communicate with client device 1020 using control messages and data messages to adjust to changing network conditions as the video is played. These control messages can include commands for enabling control functions such as fast forward, fast reverse, pausing, or seeking to a particular part of the file at the client.

Since streaming component 1007 transmits video data only as needed and at the rate that is needed, precise control over the number of streams served can be maintained. The viewer will not be able to view high data rate videos over a lower data rate transmission medium. However, streaming media servers (1) provide users random access to the video file, (2) allow monitoring of who is viewing what video programs and how long they are watched (3) use transmission bandwidth more efficiently, since only the amount of data required to support the viewing experience is transmitted, and (4) the video file is not stored in the viewer's computer, but discarded by the media player, thus allowing more control over the content.

Streaming component 1007 may use TCP-based protocols, such as HTTP and Real Time Messaging Protocol (RTMP). Streaming component 1007 can also deliver live webcasts and can multicast, which allows more than one client to tune into a single stream, thus saving bandwidth. Streaming media players may not rely on buffering the whole video to provide random access to any point in the media program. Instead, this is accomplished through the use of control messages transmitted from the media player to the streaming media server. Other protocols used for streaming are Hypertext Transfer Protocol (HTTP) live streaming (HLS) or Dynamic Adaptive Streaming over HTTP (DASH). The HLS and DASH protocols deliver video over HTTP via a playlist of small segments that are made available in a variety of bitrates typically from one or more content delivery networks (CDNs). This allows a media player to switch both bitrates and content sources on a segment-by-segment basis. The switching helps compensate for network bandwidth variances and also infrastructure failures that may occur during playback of the video.

The delivery of video content by streaming may be accomplished under a variety of models. In one model, the user pays for the viewing of video programs, for example, paying a fee for access to the library of media programs or a portion of restricted media programs, or using a pay-per-view service. In another model widely adopted by broadcast television shortly after its inception, sponsors pay for the presentation of the media program in exchange for the right to present advertisements during or adjacent to the presentation of the program. In some models, advertisements are inserted at predetermined times in a video program, which times may be referred to as “ad slots” or “ad breaks.” With streaming video, the media player may be configured so that the client device cannot play the video without also playing predetermined advertisements during the designated ad slots.

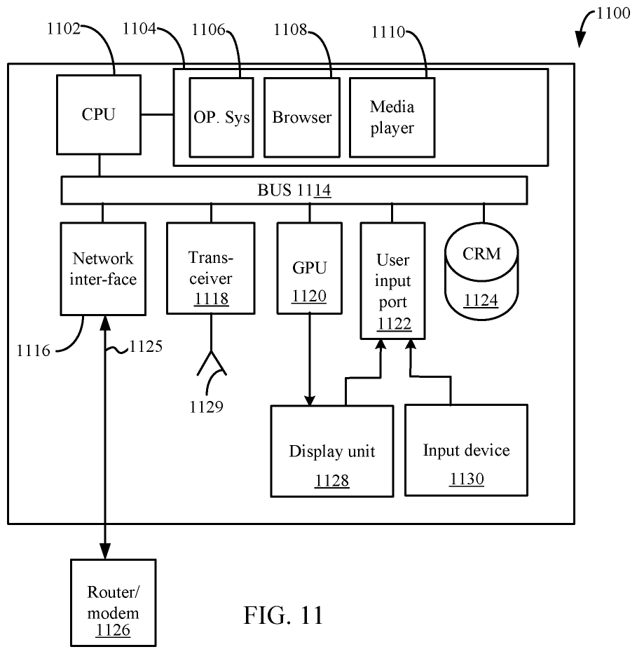

Referring to FIG. 11, a diagrammatic view of an apparatus 1100 for viewing video content and advertisements is illustrated. In selected embodiments, the apparatus 1100 may include a processor (CPU) 1102 operatively coupled to a processor memory 1104, which holds binary-coded functional modules for execution by the processor 1102. Such functional modules may include an operating system 1106 for handling system functions such as input/output and memory access, a browser 1108 to display web pages, and media player 1110 for playing video. The memory 1104 may hold additional modules not shown in FIG. 11, for example modules for performing other operations described elsewhere herein.

A bus 1114 or other communication component may support communication of information within the apparatus 1100. The processor 1102 may be a specialized or dedicated microprocessor configured or operable to perform particular tasks in accordance with the features and aspects disclosed herein by executing machine-readable software code defining the particular tasks. Processor memory 1104 (e.g., random access memory (RAM) or other dynamic storage device) may be connected to the bus 1114 or directly to the processor 1102, and store information and instructions to be executed by a processor 1102. The memory 1104 may also store temporary variables or other intermediate information during execution of such instructions.

A computer-readable medium in a storage device 1124 may be connected to the bus 1114 and store static information and instructions for the processor 1102; for example, the storage device (CRM) 1124 may store the modules 1106, 1108, 1110 and 1112 when the apparatus 1100 is powered off, from which the modules may be loaded into the processor memory 1104 when the apparatus 1100 is powered up. The storage device 1124 may include a non-transitory computer-readable storage medium holding information, instructions, or some combination thereof, for example instructions that when executed by the processor 1102, cause the apparatus 1100 to be configured or operable to perform one or more operations of a method as described herein.

A communication interface 1116 may also be connected to the bus 1114. The communication interface 1116 may provide or support two-way data communication between the apparatus 1100 and one or more external devices, e.g., the streaming system 1000, optionally via a router/modem 1126 and a wired or wireless connection. In the alternative, or in addition, the apparatus 1100 may include a transceiver 1118 connected to an antenna 1129, through which the apparatus 1100 may communicate wirelessly with a base station for a wireless communication system or with the router/modem 1126. In the alternative, the apparatus 1100 may communicate with a video streaming system 1000 via a local area network, virtual private network, or other network. In another alternative, the apparatus 1100 may be incorporated as a module or component of the system 1000 and communicate with other components via the bus 1114 or by some other modality.

The apparatus 1100 may be connected (e.g., via the bus 1114 and graphics processing unit 1120) to a display unit 1128. A display 1128 may include any suitable configuration for displaying information to an operator of the apparatus 1100. For example, a display 1128 may include or utilize a liquid crystal display (LCD), touchscreen LCD (e.g., capacitive display), light emitting diode (LED) display, projector, or other display device to present information to a user of the apparatus 1100 in a visual display.

One or more input devices 1130 (e.g., an alphanumeric keyboard, microphone, keypad, remote controller, game controller, camera or camera array) may be connected to the bus 1114 via a user input port 1122 to communicate information and commands to the apparatus 1100. In selected embodiments, an input device 1130 may provide or support control over the positioning of a cursor. Such a cursor control device, also called a pointing device, may be configured as a mouse, a trackball, a track pad, touch screen, cursor direction keys or other device for receiving or tracking physical movement and translating the movement into electrical signals indicating cursor movement. The cursor control device may be incorporated into the display unit 1128, for example using a touch sensitive screen. A cursor control device may communicate direction information and command selections to the processor 1102 and control cursor movement on the display 1128. A cursor control device may have two or more degrees of freedom, for example allowing the device to specify cursor positions in a plane or three-dimensional space.

Some embodiments may be implemented in a non-transitory computer-readable storage medium for use by or in connection with the instruction execution system, apparatus, system, or machine. The computer-readable storage medium contains instructions for controlling a computer system to perform a method described by some embodiments. The computer system may include one or more computing devices. The instructions, when executed by one or more computer processors, may be configured or operable to perform that which is described in some embodiments.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of some embodiments may be implemented. The above examples and embodiments should not be deemed to be the only embodiments and are presented to illustrate the flexibility and advantages of some embodiments as defined by the following claims. Based on the above disclosure and the following claims, other arrangements, embodiments, implementations and equivalents may be employed without departing from the scope hereof as defined by the claims.

What is claimed is:

1. A method comprising:
receiving, by a computing device, original placement opportunities for one or more campaigns;
determining, by the computing device, whether to enlarge a goal for the one or more campaigns or add new campaigns;
enlarging, by the computing device, the goal for the one or more advertisements or adding one or more campaigns for a plurality of delivery pressure values;
simulating, by the computing device, delivery of advertisements for the one or more campaigns based on the added campaigns or enlarged goal to generate a simulated delivery of advertisements for the plurality of delivery pressure values;
generating, by the computing device, an area of demand for a portion of the plurality of delivery pressure values based on an under-delivery of advertisements compared to an advertisement inventory; and
calculating, by the computing device, a difference between a maximum delivery of advertisements based on the simulated delivery of advertisement and the inventory of advertisements in the area of demand.

2. The method of claim 1, wherein determining whether to enlarge the goal or add the new campaigns comprises selecting a combination of enlarging the goal and adding the new campaigns.

3. The method of claim 1, wherein enlarging the goal comprises adding goals for placing advertisements for the one or more campaigns.

4. The method of claim 1, wherein adding the one or more campaigns comprise adding additional campaigns to place advertisements.

5. The method of claim 1, wherein simulating the delivery of advertisements comprises:
receiving historical advertisement requests; and
placing advertisements from the one or more campaigns in the historical advertisement requests.

6. The method of claim 5, wherein placing advertisements from the one or more campaign comprises:
using the enlarged goal to place the advertisements to increase delivery pressure to one of the plurality of delivery pressure values.

7. The method of claim 5, wherein placing advertisements from the one or more campaign comprises:
using the added campaigns to place the advertisements to increase delivery pressure to one of the plurality of delivery pressure values.

8. The method of claim 1, wherein generating the reasonable area of demand comprises:
comparing a ratio of the under-delivery of advertisements compared to the advertisement inventory to a threshold.

9. The method of claim 8, wherein the threshold is a value of the ratio of the under-delivery of advertisements compared to the advertisement inventory.

10. The method of claim 8, wherein the threshold is a speed of change for the ratio of the under-delivery of advertisements compared to the advertisement inventory.

11. The method of claim 1, wherein calculating the difference between the maximum delivery of advertisements base on the simulated delivery of advertisement and the inventory of advertisements in the reasonable area of demand comprises:
calculating a difference between a total of the maximum delivery of advertisements in the area of demand and a total of the inventory of advertisements in the area of demand.

12. The method of claim 1, wherein enlarging the goal for the one or more advertisements or adding one or more campaigns for the one or more campaigns for a plurality of delivery pressure values comprises:
enlarging the goal for the one or more advertisements for each of the plurality of delivery pressure values or adding one or more campaigns for each of the plurality of delivery pressure values.

13. The method of claim 1, wherein simulating the delivery of advertisements for the one or more campaigns comprises:
timing the placing of advertisements in the delivery of advertisements.

14. A non-transitory computer-readable storage medium containing instructions, that when executed, control a computer system to be operable for:
receiving original placement opportunities for one or more campaigns;
determining whether to enlarge a goal for the one or more campaigns or add new campaigns;
enlarging the goal for the one or more advertisements or adding one or more campaigns for a plurality of delivery pressure values;
simulating delivery of advertisements for the one or more campaigns based on the added campaigns or enlarged goal to generate a simulated delivery of advertisements for the plurality of delivery pressure values;
generating an area of demand for a portion of the plurality of delivery pressure values based on an under-delivery of advertisements compared to an advertisement inventory; and
calculating a difference between a maximum delivery of advertisements based on the simulated delivery of advertisement and the inventory of advertisements in the area of demand.

15. The non-transitory computer-readable storage medium of claim 14, wherein determining whether to enlarge the goal or add the new campaigns comprises selecting a combination of enlarging the goal and adding the new campaigns.

16. The non-transitory computer-readable storage medium of claim 14, wherein enlarging the goal comprises adding goals for placing advertisements for the one or more campaigns.

17. The non-transitory computer-readable storage medium of claim 14, wherein adding the one or more campaigns comprises adding additional campaigns to place advertisements.

18. The non-transitory computer-readable storage medium of claim 14, wherein simulating the delivery of advertisements comprises:
receiving historical advertisement requests; and
placing advertisements from the one or more campaigns in the historical advertisement requests.

19. The non-transitory computer-readable storage medium of claim 14, wherein generating the reasonable area of demand comprises:
comparing a ratio of the under-delivery of advertisements compared to the advertisement inventory to a threshold.

20. An apparatus comprising:
one or more computer processors; and
a non-transitory computer-readable storage medium comprising instructions, that when executed, control the one or more computer processors to be operable for:
receiving original placement opportunities for one or more campaigns;
determining whether to enlarge a goal for the one or more campaigns or add new campaigns;
enlarging the goal for the one or more advertisements or adding one or more campaigns for a plurality of delivery pressure values;
simulating delivery of advertisements for the one or more campaigns based on the added campaigns or enlarged goal to generate a simulated delivery of advertisements for the plurality of delivery pressure values;
generating an area of demand for a portion of the plurality of delivery pressure values based on an under-delivery of advertisements compared to an advertisement inventory; and
calculating a difference between a maximum delivery of advertisements based on the simulated delivery of advertisement and the inventory of advertisements in the area of demand.
